(19) United States
(12) Patent Application Publication
(10) Pub. No.: US 2013/0288614 A1
(43) Pub. Date: Oct. 31, 2013

(54) TRANSCEIVER AND VOLTAGE CALIBRATION METHOD THEREOF

(71) Applicant: REALTEK SEMICONDUCTOR CORPORATION, Hsinchu (TW)

(72) Inventor: Chien-Ming WU, Zhubei City (TW)

(73) Assignee: REALTEK SEMICONDUCTOR CORPORATION, Hsinchu (TW)

(21) Appl. No.: 13/838,632

(22) Filed: Mar. 15, 2013

(30) Foreign Application Priority Data
Apr. 30, 2012 (TW) 101115295

(51) Int. Cl. H04B 1/40

(52) U.S. Cl. CPC H04B 1/40
USPC 455/73

(57) ABSTRACT

A transceiver and a voltage calibration method thereof are provided. The transceiver includes a transmitting circuit, a receiving circuit, and a processing circuit. The transmitting circuit generates a transmitting voltage. The receiving circuit, which is electrically connected to the transmitting circuit, receives a reference voltage and the transmitting voltage to generate a reference signal, and a measurement signal respectively. The processing circuit, which is electrically connected to the transmitting circuit and receiving circuit, calibrates the transmitting voltage according to the reference signal and the measurement signal.

This application claims priority to Taiwan Patent Application No. 101115295 filed on Apr. 30, 2012, which is hereby incorporated by reference in its entirety.

### CROSS-REFERENCES TO RELATED APPLICATIONS

Not applicable.

### BACKGROUND OF THE INVENTION

1. Field of the Invention

The present invention relates to a transceiver and a voltage calibration method thereof. More particularly, the receiving circuit of the transceiver of the present invention receives a reference voltage and receives the transmitting voltage from a transmitting circuit so that the processing circuit calibrates the transmitting voltage generated by the transmitting circuit according to the reference voltage and the transmitting voltage.

2. Descriptions of the Related Art

The widespread use of broadband networks has greatly promoted the development of network services and related applications. General personal computers (PCs) transmit data through Ethernets. With Ethernets, the voltage that is outputted by a transceiver must be very accurate, with an allowable error ranging between −5% and +5%. However, since impedance mismatch may occur at the output end of the transceiver, an additional calibration circuit must be used to calibrate the output voltage to ensure that the error is restricted to range between −5% and +5%. As a result, the additional calibration circuit in the transceiver increases the area of the transceiver and costs. Furthermore, in audio processing and other communication system fields, the transceiver is also required to output a very precise voltage.

Accordingly, an urgent need exists in the art to provide a solution capable of calibrating the output voltage without the need of using an additional calibration circuit to reduce costs.

### SUMMARY OF THE INVENTION

An objective of the present invention is to provide a transceiver and a voltage calibration method thereof. The transceiver of the present invention may be applied to Ethernets, audio processing or other communication system fields. The transceiver of the present invention can use an analog front end (AFE) circuit itself directly to calibrate a transmitting voltage (an output voltage) of a transmitting end without the need of an additional calibration circuit. Thereby, the area of the transceiver and costs are both reduced.

To achieve the aforesaid objective, the present invention discloses a transceiver, which comprises a transmitting circuit, a receiving circuit and a processing circuit. The transmitting circuit is configured to generate a transmitting voltage. The receiving circuit, which is electrically connected to the transmitting circuit, is configured to receive a reference voltage and the transmitting voltage respectively and generate a reference signal according to the reference voltage and a measurement signal according to the transmitting voltage. The processing circuit, which is electrically connected to the transmitting circuit and the receiving circuit, is configured to calculate a calibration value according to the reference signal and the measurement signal and calibrate the transmitting voltage according to the calibration value.

Furthermore, the present invention further discloses a voltage calibration method for use in a transceiver. The transceiver comprises a transmitting circuit, a receiving circuit and a processing circuit. The receiving circuit is electrically connected to the transmitting circuit. The processing circuit is electrically connected to the transmitting circuit and the receiving circuit. The voltage calibration method comprises the following steps of: (a) enabling the receiving circuit to receive a reference voltage and generate a reference signal according to the reference voltage; (b) enabling the transmitting circuit to generate a transmitting voltage; (c) enabling the receiving circuit to receive the transmitting voltage and generate a measurement signal according to the transmitting voltage; and (d) enabling the processing circuit to calculate a calibration value according to the reference signal and the measurement signal and calibrate the transmitting voltage according to the calibration value.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a schematic view of a transceiver 1 of a first embodiment;

FIG. 2 is a schematic view of a transceiver 2 of a second embodiment;

FIG. 3 is a schematic view of a transceiver 3 of a third embodiment;

FIG. 4 is a schematic view of a transceiver 4 of a fourth embodiment;

FIG. 5 is a schematic view of a transceiver 5 of a fifth embodiment; and

FIG. 6 is a flowchart diagram of a voltage calibration method of a sixth embodiment.

### DESCRIPTION OF THE PREFERRED EMBODIMENT

In the following descriptions, the present invention will be explained with reference to embodiments thereof. These embodiments are not intended to limit the present invention to any specific environment, applications or particular implementations described in these embodiments. Therefore, the description of these embodiments is only for the purpose of illustration rather than limitation. It shall be appreciated that in the following embodiments and attached drawings, elements not directly related to the present invention are omitted from depiction; and dimensional relationships among individual elements in the attached drawings are illustrated only for ease of understanding but not to limit the actual scale.

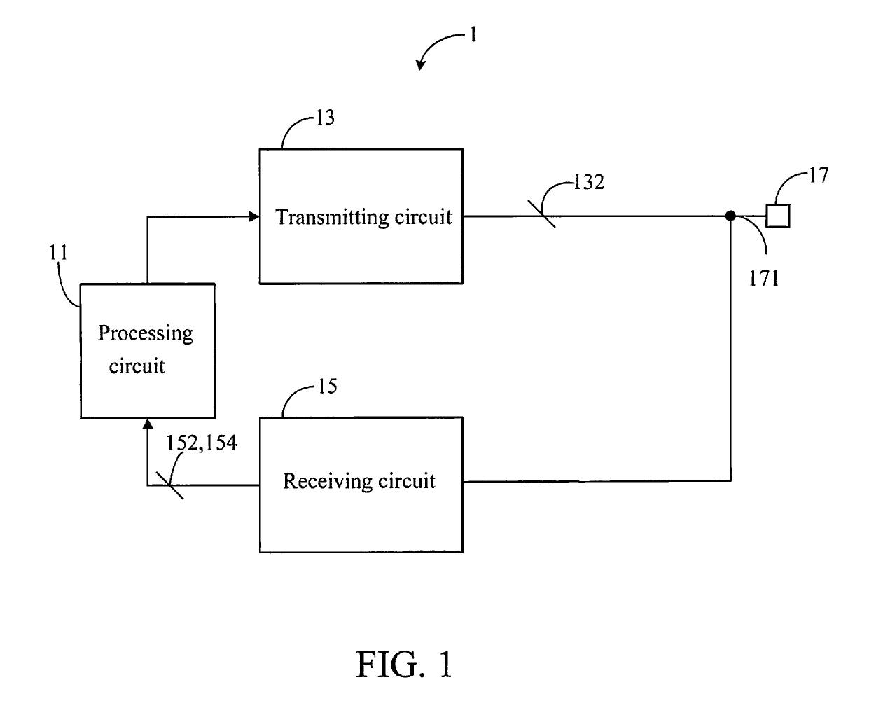

A first embodiment of the present invention is shown in FIG. 1, which is a schematic view of a transceiver 1. The transceiver 1 comprises a processing circuit 11, a transmitting circuit 13, a receiving circuit 15 and an output pin 17. The transceiver 1 may be applied to Ethernets, audio processing or other communication system fields.

The transmitting circuit 13 generates a transmitting voltage 132. The output pin 17 is electrically connected to the transmitting circuit 13 via an output end point 171 to output the transmitting voltage 132, and is electrically connected to the receiving circuit 15 via the output end point 171. During the typical transmission of a signal, the receiving circuit 15 receives an input voltage (not shown) from the external via the output pin 17. In this embodiment, the receiving circuit 15 further receives the transmitting voltage 132 from the output end point 171, and generates a measurement signal 152 according to the transmitting voltage 132. Furthermore, the receiving circuit 15 also receives a reference voltage (not shown), and generates a reference signal 154 according to the reference voltage. It shall be noted that the order in which the transmitting voltage 132 and the reference voltage are received by the receiving circuit 15 may be changed, and is thus, not intended to limit the present invention.

Then, the processing circuit 11 calculates a calibration value according to the reference signal 154 and the measurement signal 152, and calibrates the transmitting voltage 132 according to the calibration value. In detail, the transceiver 1 of the present invention uses an analog front end (AFE) circuit (i.e., the transmitting circuit 13 and the receiving circuit 15) in itself. The receiving circuit 15 is used to receive the transmitting voltage 132 of the transmitting circuit 13 to generate the measurement signal 152 and receive the reference voltage to generate the reference signal 154. Because the reference voltage is a constant and stable voltage, the processing circuit 11 can calibrate the transmitting voltage 132 generated by the transmitting circuit 13 according to a difference value between the measurement signal 152 and the reference signal 154.

For example, if the transmitting voltage 132 is 1.5 volts (V) and the reference voltage is 1 V, then the receiving circuit 15 generates the measurement signal 152 representing 1.5 V and the reference signal 154 representing 1 V respectively. Then, the processing circuit 11 changes the transmitting voltage 132 according to the difference value between the measurement signal 152 and the reference signal 154 so that the transmitting voltage 132 is calibrated to be substantially equal to the reference voltage. Furthermore, the processing circuit 11 may change the transmitting voltage 132 in one step or in multiple steps (i.e., stepwise adjustment) to make the transmitting voltage 132 substantially equal to the reference voltage.

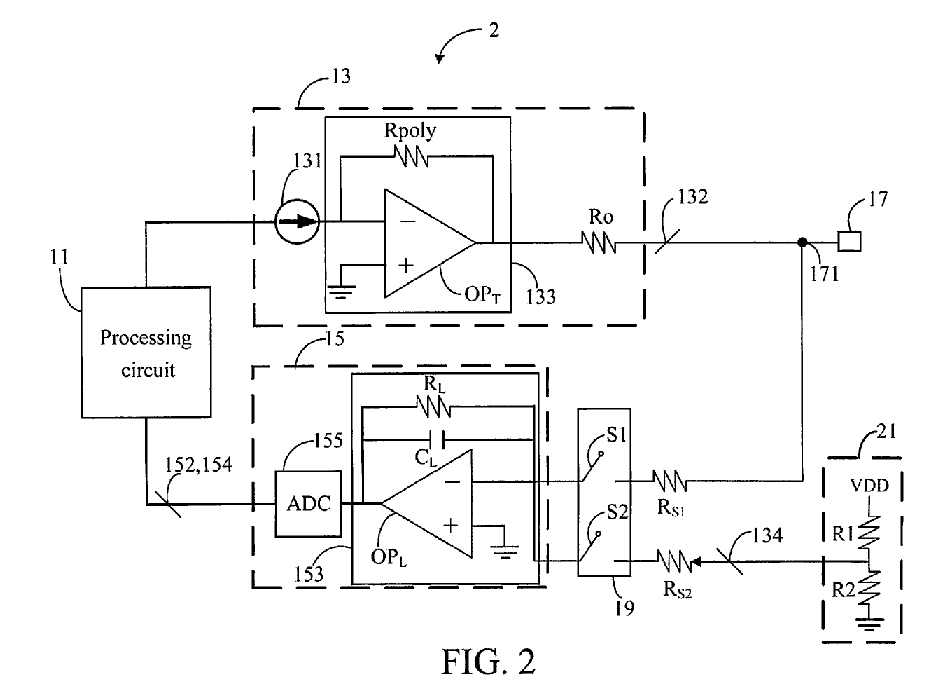

A second embodiment of the present invention is shown in FIG. 2, which is a schematic view of a transceiver 2. The transmitting circuit 13 has a variable current source 131, a linear driver 133 and a resistor Ro. The transmitting circuit 13 generates the transmitting voltage 132 according to the variable current source 131. The linear driver 133 comprises a resistor Rpoly and an amplifier OP_{T}. In the Ethernets, the resistor Ro usually has a resistance of 50 Ω.

The receiving circuit 15 comprises an analog-to-digital converter (ADC) 155 and a low-pass filter 153. The low-pass filter 153 comprises a resistor R_{L}, a capacitor C_{L} and an amplifier OP_{L}. The ADC 155 generates the reference signal 154 and the measurement signal 152. By comparing the reference signal 154 with the measurement signal 152, the processing circuit 11 adjusts the variable current source 131 to calibrate the transmitting voltage 132.

In this embodiment, the transceiver 2 further comprises a switch set 19 and a resistive divider circuit 21. The switch set 19 is electrically connected to the transmitting circuit 13, the receiving circuit 15 and the resistive divider circuit 21. The resistive divider circuit 21 comprises divider resistors R1 and R2, and is connected to a constant voltage VDD to generate the reference voltage 134.

In detail, the switch set 19 comprises a first switch S1 and a second switch S2. The first switch S1 is coupled to the output end point 171 via a resistor R_{S1}, and the second switch S2 is coupled to the resistive divider circuit 21 via a resistor R_{S2}. The receiving circuit 15 is electrically connected to the output end point 171 via the first switch S1 to receive the transmitting voltage 132, and is electrically connected to the resistive divider circuit 21 via the second switch S2 to receive the reference voltage 134. Specifically, when the first switch S1 is on, the second switch S2 is off and the receiving circuit 15 receives the transmitting voltage 132 via the first switch S1. Conversely, when the first switch S1 is off, the second switch S2 is on and the receiving circuit 15 receives the reference voltage 134 via the second switch S2.

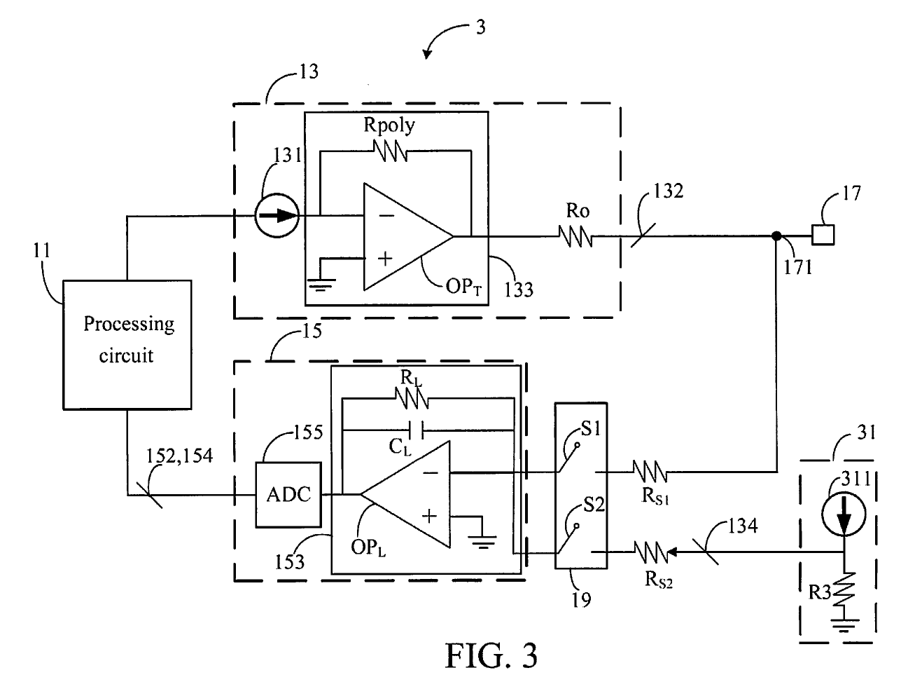

A third embodiment of the present invention is shown in FIG. 3, which is a schematic view of a transceiver 3. Unlike the second embodiment, the transceiver 3 of this embodiment comprises a reference voltage circuit 31 rather than the resistive divider circuit 21. The reference voltage circuit 31 comprises a reference current source 311 and a resistor R3 to generate the reference voltage 134. The switch set 19 is electrically connected to the reference voltage circuit 31 so that the receiving circuit 15 receives the reference voltage 134 from the reference voltage circuit 31 via the switch set 19 and generates the reference signal 154 according to the reference voltage 134. Additionally, the switch set 19 is also electrically connected to the output end point 171 so that the receiving circuit 15 receives the transmitting voltage 132 via the switch set 19 and generates the measurement signal 152 according to the transmitting voltage 132.

It shall be appreciated that other than the resistive divider circuit 21 of the second embodiment and the reference voltage circuit 31 of the third embodiment, any circuit that is capable of generating a constant voltage can be used in the transceiver 2 and the transceiver 3 to generate the reference voltage 134; and therefore, any circuit that can replace the resistive divider circuit 21 or the reference voltage circuit 31 shall be covered within the scope of the present invention.

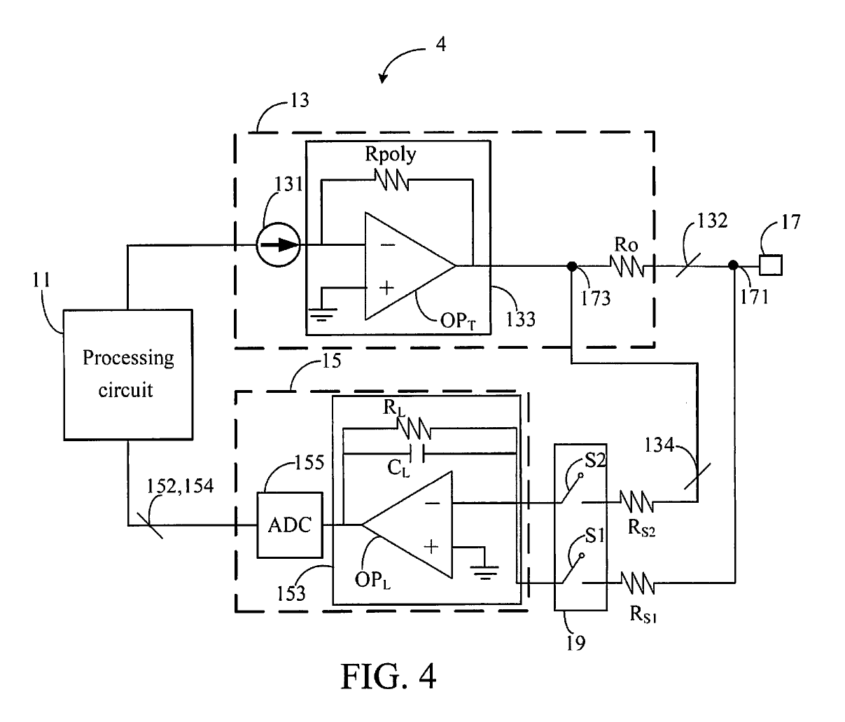

A fourth embodiment of the present invention is shown in FIG. 4, which is a schematic view of a transceiver 4. In this embodiment, the transceiver 4 is suitable for use in an Ethernet that supports a transmission speed of 10/100/1000 Mbps (mega bit per second).

Unlike the second and third embodiments, in this embodiment, the second switch S2 of the switch set 19 is coupled to a mid-point 173 of the transmitting circuit 13 via a resistor R_{S2}. The mid-point 173 is located between the linear driver 133 and the resistor Ro. The receiving circuit 15 receives the reference voltage 134 from the mid-point 173 via the switch set 19 and generates the reference signal 154 according to the reference voltage 134. Similarly, the receiving circuit 15 also receives the transmitting voltage 132 from the output end point 171 via the switch set 19 and generates the measurement signal 152 according to the transmitting voltage 132.

In detail, the resistor Ro of the transmitting circuit and the external load can cause an impedance mismatch at the output end of the transceiver, the voltage of the mid-point 173 is relatively stable as compared to the voltage of the output end point 171. Thereby, the transmitting voltage 132 can also be calibrated by using the voltage of the mid-point 173 as the reference voltage 134.

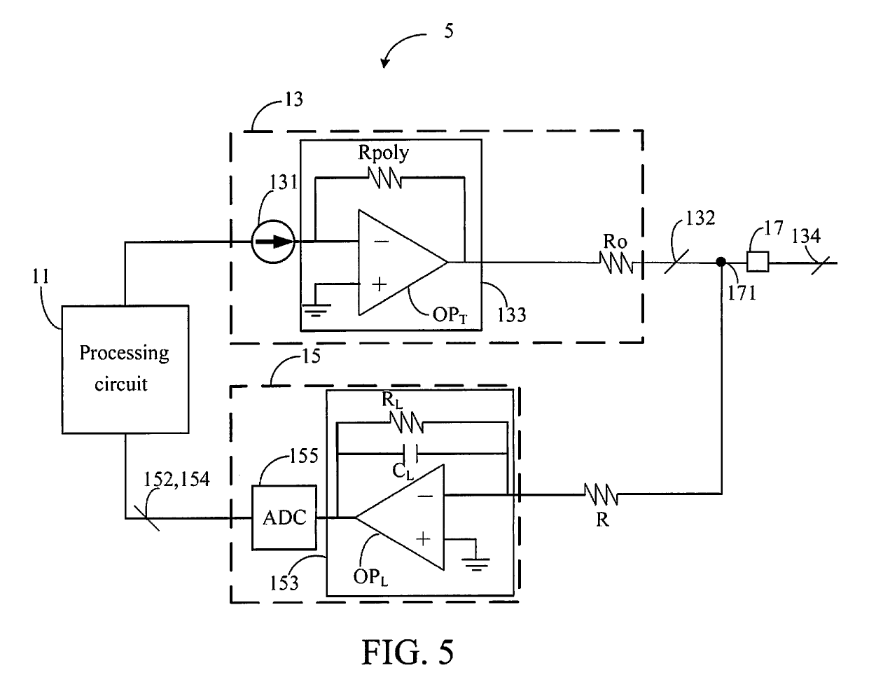

A fifth embodiment of the present invention is shown in FIG. 5, which is a schematic view of a transceiver 5. In this embodiment, the receiving circuit 15 of the transceiver 5, which is coupled to the output end point 171 via a resistor R, receives the reference voltage 134 from the output end point 171 and generates the reference signal 154 according to the reference voltage 134. Specifically, in this embodiment, the output pin 17 may first receive an external voltage from an external circuit, and the receiving circuit receives the external voltage as the reference voltage 134 via the output pin 17. Then, the receiving circuit 15 receives the transmitting voltage 132 from the output end point 171 and generates the measurement signal 152 according to the transmitting voltage 132. Because the external circuit can generate a stable external voltage, the processing circuit 11 can calibrate the transmitting voltage 132 transmitted by the transmitting circuit 13 by comparing the transmitting voltage 132 with the reference voltage 134.

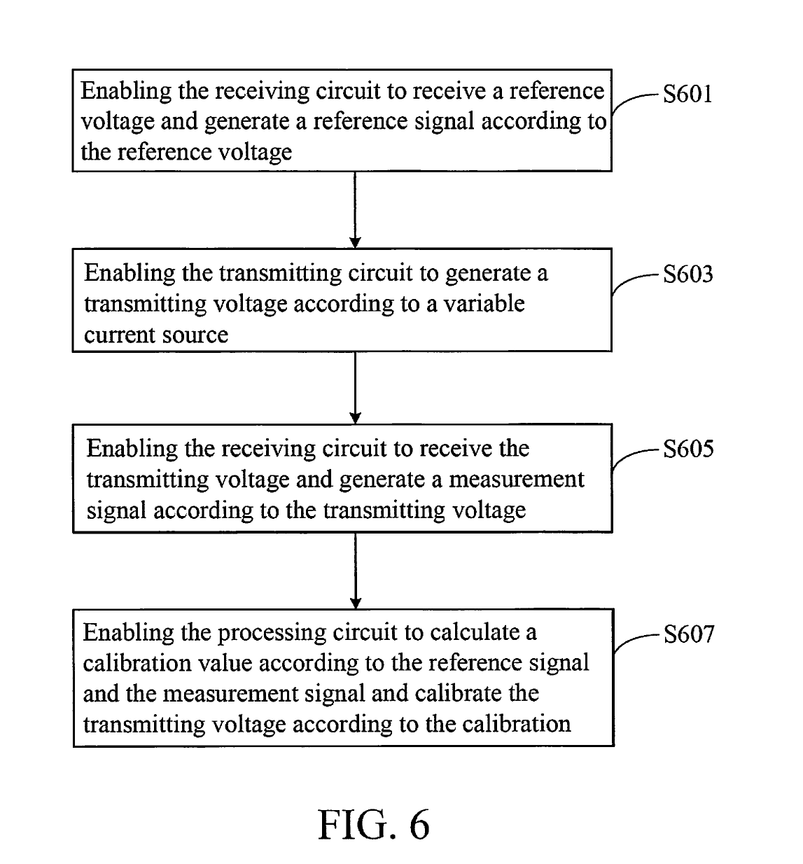

A sixth embodiment of the present invention is shown in FIG. 6, which is a flowchart diagram of a voltage calibration method of the present invention. The voltage calibration method of the present invention is for use in a transceiver (e.g., the transceivers described in the first to fifth embodiments). The transceiver comprises a transmitting circuit, a receiving circuit and a processing circuit. The receiving circuit is electrically connected to the transmitting circuit. The processing circuit is electrically connected to the transmitting circuit and the receiving circuit.

First, step S601 is executed to enable the receiving circuit to receive a reference voltage and generate a reference signal according to the reference voltage. Next, step S603 is executed to enable the transmitting circuit to generate a transmitting voltage. Then, step S605 is executed to enable the receiving circuit to receive the transmitting voltage and generate a measurement signal according to the transmitting voltage. Finally, step S607 is executed to enable the processing circuit to calculate a calibration value according to the reference signal and the measurement signal and calibrate the transmitting voltage according to the calibration value. It shall be appreciated that step S601 may also be executed after step S605. In other words, the execution order of steps S601, S603, and S605 is not intended to limit the present invention.

In addition to the aforesaid steps, the voltage calibration method of the sixth embodiment can also execute all the operations and functions set forth in the first to fifth embodiments. The method in which the sixth embodiment executes these operations and functions can be readily appreciated by those of ordinary skill in the art based on the explanation of the first to fifth embodiments, and thus, will not be further described herein.

According to the above descriptions, the transceiver of the present invention may be applied to Ethernets, audio processing or other communication system fields. The transceiver of the present invention can use an AFE circuit in itself to calibrate the transmitting voltage (the output voltage) of the transmitting end. Thereby, with the elimination of the additional calibration circuit, the present invention can reduce the area of the transceiver and costs.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A transceiver, comprising:
a transmitting circuit, being configured to generate a transmitting voltage;
a receiving circuit, being electrically connected to the transmitting circuit, and being configured to receive a reference voltage and the transmitting voltage respectively and generate a reference signal according to the reference voltage and a measurement signal according to the transmitting voltage; and
a processing circuit, being electrically connected to the transmitting circuit and the receiving circuit, and being configured to calculate a calibration value according to the reference signal and the measurement signal and calibrate the transmitting voltage according to the calibration value.

2. The transceiver of claim 1, wherein the transmitting circuit comprises a variable current source, the transmitting circuit generates the transmitting voltage according to the variable current source, and the processing circuit adjusts the variable current source according to the calibration value so as to calibrate the transmitting voltage.

3. The transceiver of claim 1, further comprising a switch set electrically connected to the receiving circuit and the transmitting circuit, wherein the receiving circuit respectively receives the reference voltage and the transmitting voltage via the switch set.

4. The transceiver of claim 3, wherein the switch set further comprises a first switch and a second switch, when the first switch is on, the second switch is off and the receiving circuit receives the transmitting voltage via the first switch, and when the first switch is off, the second switch is on and the receiving circuit receives the reference voltage via the second switch.

5. The transceiver of claim 3, further comprising a resistive divider circuit electrically connected to the switch set, wherein the receiving circuit receives the reference voltage from the resistive divider circuit via the switch set.

6. The transceiver of claim 3, further comprising a reference voltage circuit electrically connected to the switch set, wherein the receiving circuit receives the reference voltage from the reference voltage circuit via the switch set.

7. The transceiver of claim 4, wherein the transceiver is used in an Ethernet, and the transceiver further comprises an output pin and an output end point, wherein the transmitting circuit has a mid-point and a resistor, the mid-point is electrically connected to the output end point via the resistor, the output end point is electrically connected to the output pin, the output pin is configured to output the transmitting voltage, the switch set is electrically connected to the mid-point, and the receiving circuit receives the reference voltage from the mid-point via the switch set.

8. The transceiver of claim 1, further comprising an output pin and an output end point, wherein the transmitting circuit and the receiving circuit are electrically connected to the output end point, the output end point is electrically connected to the output pin, the output pin is configured to output the transmitting voltage and receive an external voltage, and the receiving circuit receives the external voltage as the reference voltage from the output pin.

9. The transceiver of claim 1, wherein the receiving circuit further comprises an analog-to-digital converter (ADC) for generating the reference signal and the measurement signal.

10. A voltage calibration method used in a transceiver, the transceiver comprising a transmitting circuit, a receiving circuit, and a processing circuit, the receiving circuit being electrically connected to the transmitting circuit, the processing circuit being electrically connected to the transmitting circuit and the receiving circuit, and the voltage calibration method comprising the following steps of:
(a) enabling the receiving circuit to receive a reference voltage and generate a reference signal according to the reference voltage;
(b) enabling the transmitting circuit to generate a transmitting voltage;
(c) enabling the receiving circuit to receive the transmitting voltage and generate a measurement signal according to the transmitting voltage; and
(d) enabling the processing circuit to calculate a calibration value according to the reference signal and the measurement signal and calibrate the transmitting voltage according to the calibration value.

11. The voltage calibration method of claim 10, wherein the transmitting circuit comprises a variable current source, the step (b) is to enable the transmitting circuit to generate the transmitting voltage according to the variable current source, and the step (d) is to enable the processing circuit to adjust the variable current source according to the calibration value so as to calibrate the transmitting voltage.

12. The voltage calibration method of claim 10, wherein the transceiver further comprises a switch set electrically connected to the receiving circuit and the transmitting circuit, wherein the step (a) is to enable the receiving circuit to receive the reference voltage via the switch set, and the step (c) is to enable the receiving circuit to receive the transmitting voltage via the switch set.

13. The voltage calibration method of claim 12, wherein the switch set further comprises a first switch and a second switch, and when the first switch is on, the second switch is off and the step (c) is to enable the receiving circuit to receive the transmitting voltage via the first switch, and when the first switch is off, the second switch is on and the step (a) is to enable the receiving circuit to receive the reference voltage via the second switch.

14. The voltage calibration method of claim 12, wherein the transceiver further comprises a resistive divider circuit electrically connected to the switch set, and the step (a) is to enable the receiving circuit to receive the reference voltage from the resistive divider circuit via the switch set.

15. The voltage calibration method of claim 12, wherein the transceiver further comprises a reference voltage circuit electrically connected to the switch set, and the step (a) is to enable the receiving circuit to receive the reference voltage from the reference voltage circuit via the switch set.

16. The voltage calibration method of claim 12, wherein the transceiver further comprises an output pin and an output end point, the transmitting circuit has a mid-point and a resistor, the mid-point is electrically connected to the output end point via the resistor, the output end point is electrically connected to the output pin, the output pin is configured to output the transmitting voltage, the switch set is electrically connected to the mid-point, and the step (a) is to enable the receiving circuit to receive the reference voltage from the mid-point via the switch set.

17. The voltage calibration method of claim 10, wherein the transceiver further comprises an output pin and an output end point, the transmitting circuit and the receiving circuit are electrically connected to the output end point, the output end point is electrically connected to the output pin, the output pin is configured to output the transmitting voltage and receive an external voltage, and the step (a) is to enable the receiving circuit to receive the external voltage as the reference voltage from the output pin.

18. The voltage calibration method of claim 10, wherein the receiving circuit further comprises an analog-to-digital converter, the step (a) is to enable the analog-to-digital converter to generate the reference signal, and the step (c) is to enable the analog-to-digital converter to generate the measurement signal.
